(19) United States
(12) Patent Application Publication
(10) Pub. No.: US 2017/0181576 A1
(43) Pub. Date: Jun. 29, 2017

(54) Fire Pit Grilling Apparatus

(71) Applicants: Jack Kopec, New Lenox, IL (US); Elizabeth Kopec, New Lenox, IL (US)

(72) Inventors: Jack Kopec, New Lenox, IL (US); Elizabeth Kopec, New Lenox, IL (US)

(21) Appl. No.: 15/394,223

(22) Filed: Dec. 29, 2016

Related U.S. Application Data
(60) Provisional application No. 62/272,663, filed on Dec. 29, 2015.

(51) Int. Cl. A47J 37/07; F24B 1/20

(52) U.S. Cl. CPC A47J 37/07; F24B 1/207

(57) ABSTRACT

A fire pit grilling apparatus is provided. The grilling apparatus provides an adjustable grill mountable over a fire pit. The apparatus includes a frame having a pair of elongated members interconnected by a crossbar. The crossbar is rotatably coupled to ends of the elongated members such that it can rotate relative thereto. An adjustable harness couples a grill grate to the crossbar and includes a cable affixed to tethers which suspend the grill grate in a level position. A hand crank coupled to the crossbar rotates the crossbar. Rotation of the hand crank in a first direction winds the harness around the crossbar while rotation of the hand crank in a second direction unwinds the harness from the crossbar. Winding and unwinding the harness decreases and increases the height of the grill grate, respectively, relative to a surface such that a desired height over a fire pit may be achieved.

### CROSS REFERENCE TO RELATED APPLICATIONS

This application claims the benefit of U.S. Provisional Application No. 62/272,663 filed on Dec. 29, 2015. The above identified patent application is herein incorporated by reference in its entirety to provide continuity of disclosure.

### BACKGROUND OF THE INVENTION

The present invention relates to grills. More specifically, the present invention provides a fire pit grilling apparatus including a suspension mechanism for suspending a grill grate over a fire pit and adjusting the height of the grill grate thereover.

The use of grilling devices are known in the prior art. More specifically, grills having tripods and mechanisms for suspending grills over fire pits heretofore devised and utilized are known to consist basically of familiar, expected and obvious structural configurations, notwithstanding the myriad of designs encompassed by the crowded prior art which have been developed for the fulfillment of countless objectives and requirements.

While these devices fulfill their respective, particular objectives and requirements, the need remains for a fire pit grilling apparatus that has a stable configuration and a suspension mechanism for allowing a grill grate to be suspended over a fire pit, while not completely surrounding the fire pit, and that enables greater freedom of vertical movement of the grill grate to ensure that proper cooking temperatures are attained.

In these respects, the fire pit grilling apparatus according to the present invention substantially departs from the conventional concepts and designs of the prior art, and in so doing provides an apparatus primarily developed for the purpose of providing a stable grilling area over a fire pit which is capable of adjusting thereover.

### SUMMARY OF THE INVENTION

In view of the foregoing disadvantages inherent in the known types of grills now present in the prior art, the present invention provides a fire pit grilling apparatus wherein the same can be utilized for providing convenience for the user when grilling over a fire pit or open flame. The fire pit grilling apparatus comprises a frame including a pair of elongated members having a proximal end and a distal end, a crossbar including a first end a second end rotatably coupled to the proximal ends of the pair of elongated members, a support base disposed at each of the distal ends of the pair of elongated members, the support bases configured to support the frame in a vertically upright position, an adjustable harness affixed to a center of the crossbar, the harness including a cable having a proximal end and a distal end and a plurality of tethers having a first end and a second end, the proximal end of the cable being affixed to the crossbar and the first ends of the plurality of tethers being affixed to the distal end of the cable, a grill grate mounted to the second ends of the plurality of tethers, the plurality of tethers disposed evenly about a perimeter edge of the grill grate, and a hand crank coupled to the crossbar, the hand crank configured to rotate in a first direction and a second direction, thereby simultaneously rotating the crossbar upon rotation in either the first or second direction.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the fire pit grilling apparatus.

FIG. 2 shows a close-up view of the crank of the fire pit grilling apparatus

FIG. 3 shows a perspective view of the fire pit grilling apparatus positioned over a fire pit.

### DETAILED DESCRIPTION OF THE INVENTION

Reference is made herein to the attached drawings. Like reference numerals are used throughout the drawings to depict like or similar elements of the fire pit grilling apparatus. The figures are intended for representative purposes only and should not be considered to be limiting in any respect.

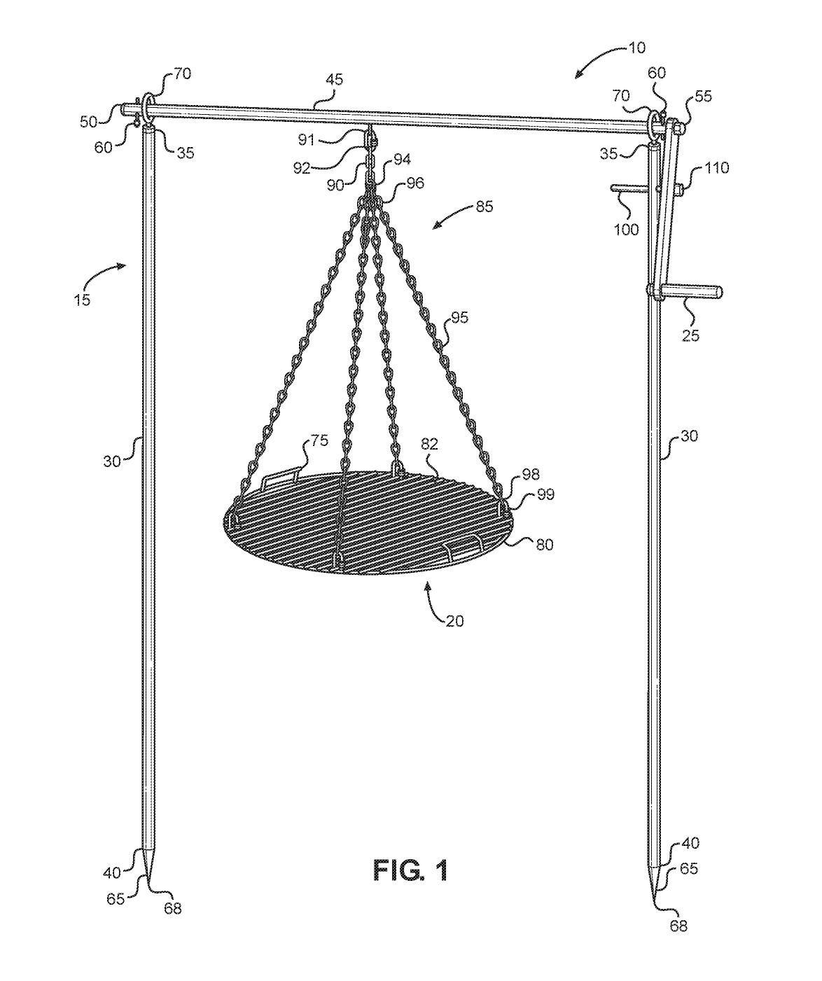

Referring now to FIG. 1, there is shown a perspective view of the fire pit grilling apparatus. The present invention provides a fire pit grilling apparatus 10 including a support frame 15 operably coupled to a grill grate 20 for spending the grill grate 20 over a fire pit or an open flame, and a hand crank 25 coupled to the support frame 15 for adjusting the vertical height of the grill grate 20 over the fire pit.

The support frame 15 includes a pair of elongated members 30, each having a proximal end 35 and a distal end 40, and a crossbar 45. The pair of elongated members 30 are interconnected by the crossbar 45 at their proximal ends 35. The pair of elongated members 30 include the same shape and size and are positioned vertically, upright and parallel relative to one another, such that they are aligned. In the depicted embodiment, the pair of elongated members 30 comprise cylindrical poles. However, in alternative embodiments, the pair of elongated members 30 may comprises any shaped bar or pole.

The crossbar 45 is positioned perpendicular relative to the pair of elongated members 30. The crossbar 45 includes a first end 50 and a second end 55 rotatably coupled to the proximal ends 35 of the pair of elongated members 30, such that the crossbar 45 can rotate clockwise and counterclockwise relative to the longitudinal axis of the pair of elongated members 30. In the depicted embodiment, the crossbar 45 comprises a cylindrical rod. However, in alternative embodiments, the crossbar 45 may comprises any cylindrical bar, pole, or tubular member. The proximal ends 35 of the pair of elongated members 30 each include a circular band 70 protruding vertically, upward and parallel relative to the pair of elongated members 30. Each of the circular bands 70 includes an aperture sized to receive the first end 50 and second 55 of the crossbar 45, respectively, therethrough. The first and second ends 50, 55 of the crossbar 45 are rotatable within the apertures of circular bands 70, such that they can rotate clockwise and counterclockwise therein.

The first and second ends 50, 55of the crossbar 45 each include a pin 60 for securing the crossbar 45 to the proximal ends 35 of the pair of elongated members 30. The pin 60 extends through the diameter of the crossbar 45 and protrudes radially outwardly from opposing sides of the crossbar 45. The length of the pin 60 is greater than the diameter of the circular band 70. In this way, the pin 60 prevents the crossbar 45 from sliding out of the circular bands 70. In one embodiment, the pin 60 comprises an eyebolt.

The distal ends 40 of the pair of elongated members 30 include a support base 65 for supporting the support frame 15 in an upright vertical position. In one embodiment, each of the support bases 65 include a pointed tip 68 for driving the distal ends 40 of the elongated members 30 into the ground and securing the support frame 15 in an upright position. In another embodiment, the support base 65 includes a plate for supporting the support frame 15 in an upright vertical position.

The grill grate 20 includes a planar frame defined by a perimeter edge 80 having a network of elongated rods 82 extending diametrically across frame. The grill grate 20 includes a handle 75 disposed on the perimeter edge 80 thereof for facilitating the grasping and positioning of the grill grate 20. In the depicted embodiment, the grill grate 20 includes a circular frame including a pair of handles disposed on opposing sides of the grill grate 20.

The grill grate 20 is operably coupled to the crossbar 45 by a harness 85 configured to suspend the grill grate 20 from the crossbar 45. The harness 85 includes a support cable 90 and a plurality of tethers 95. The support cable 90 includes a proximal end 92 that is removably attachable to a center of the crossbar 45 via a first fastener 91. In the depicted embodiment, the first fastener 91 includes a threaded connecting link, i.e., a chain connector or a quick link, for removably receiving the proximal end 92 of the support cable 90. In this way, the harness 85 can be removed from the crossbar 45 as desired. The support cable 90 extends vertically downward therefrom, such that the support link 90 is perpendicular relative to crossbar 45. Each of the plurality of tethers 95 includes a first end 96 affixed to a distal end 94 of the support cable 90 and a second end 98 affixed to the grill grate 20 via a second fastener 99. In the depicted embodiment, the second fastener 99 includes a threaded connecting link, i.e., a chain connector or quick link, for removably receiving the second end 98 of the plurality of tethers 95. In this way, the grill grate 20 can be removed from the harness 85 as desired. In the depicted embodiment, the support cable 90 and the plurality of tethers 95 include flexible linked chains that are capable of being wound about the crossbar 45.

The plurality of tethers 95 are disposed evenly around the perimeter edge 80 of the grill grate 20 and include the same size and shape, such that they suspend and balance the grill plate 20 horizontally, in a level and perpendicular position relative to the longitudinal axis of the pair of elongated members 30. Each of the plurality of tethers 95 include flexible, heat resistant members, such as metal, configured to withstand high levels of heat. In the depicted embodiment, the fire pit grilling apparatus 10 includes four tethers positioned evenly about the perimeter edge 80 of the grill grate 20. In this way, the even distribution of the tethers about the perimeter edge 80 of the grill grate 20 holds the grill grate 20 in a level, horizontal position.

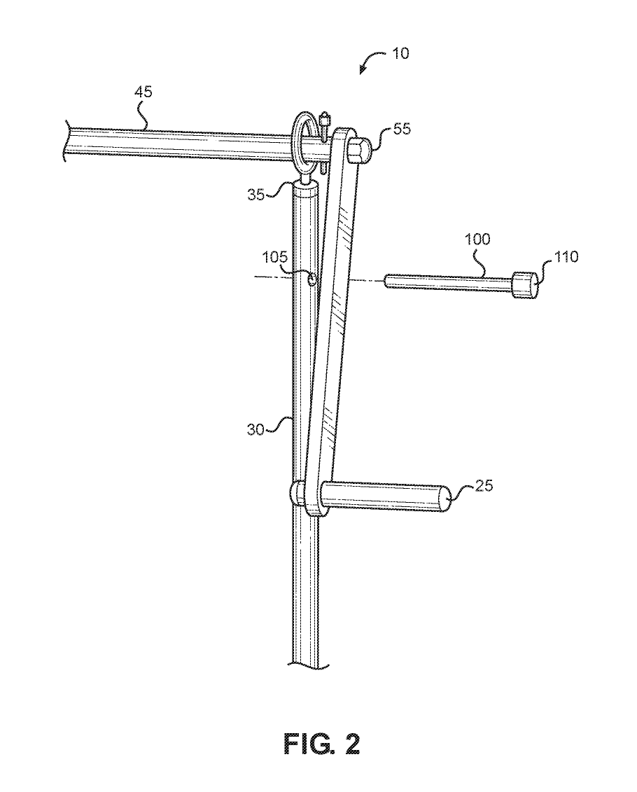

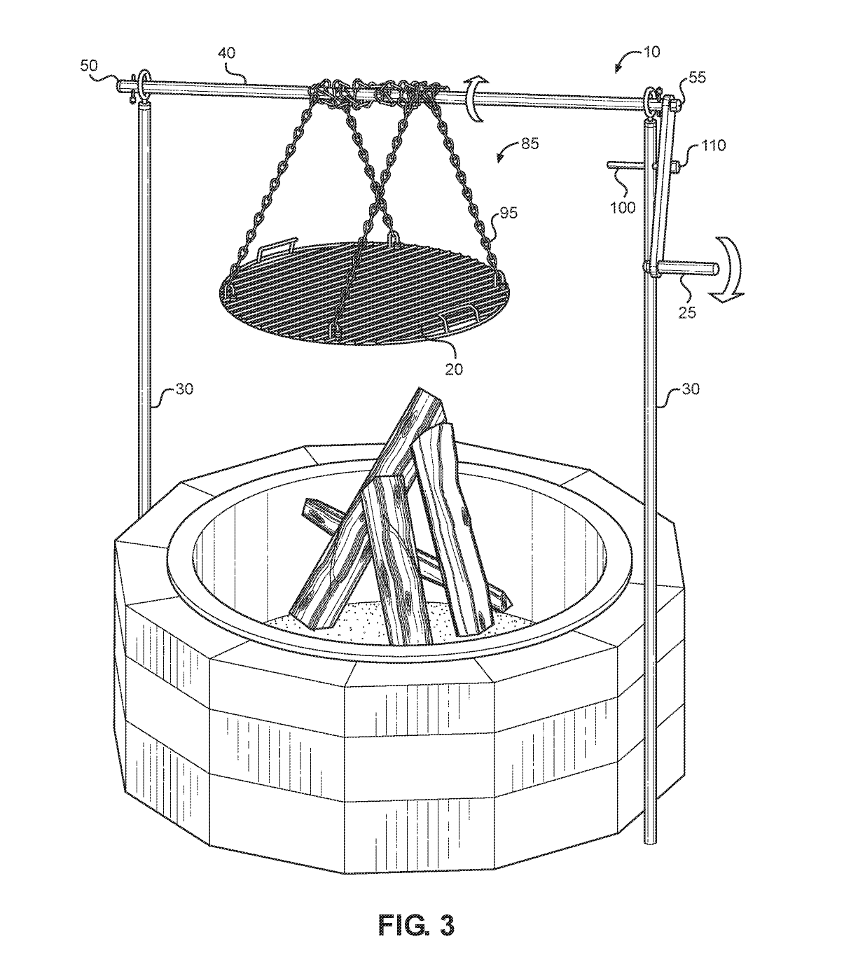

Referring now to FIGS. 2 and 3, there is shown a perspective view of the hand-crank of the fire pit grilling apparatus and a perspective view of the grill plate positioned over a fire pit, respectively. The hand crank 25 of the fire pit grilling apparatus 10 is fixedly attached to an end of the crossbar 45 and configured to adjust the vertical height of the grill grate 20 relative to the ground. In the depicted embodiment, the hand crank 25 is affixed to the second end 55 of the crossbar 45. However, in alternative embodiments, the hand crank 25 may be coupled to the first end 50 of the crossbar 45. Since, the hand crank 25 is affixed to an end of the crossbar 45 and the crossbar 45 is rotatably coupled to the proximal ends 35 of the pair of elongated members 30, rotation of the hand crank 25 in a first direction rotates the crossbar 45 in the first direction, which winds the support cable and the plurality of tethers 95 about the crossbar 45, thereby decreasing the length of the harness 85 and increasing the height of the grill grate 20 relative to the ground, as shown by FIG. 3.

Accordingly, rotation of the hand crank 25 in a second direction rotates the crossbar 45 in the second direction, unwinding the support cable and the plurality of tethers 95 from the crossbar 45, thereby increasing the length of the harness 85 and decreasing the height of the grill grate 20 relative to the ground. In the depicted embodiment, the clockwise rotation of the hand crank 25 winds the harness 85 about the crossbar 45, thereby increasing the height of the grill grate 20, while the counterclockwise rotation of the hand crank 25 unwinds the harness 85 from the crossbar 45, thereby decreasing the height of the grill grate 20.

The fire pit grilling apparatus further includes a locking pin 100 and an aperture 105 configured to receive the locking pin 100 therethrough, in order to lock the grill plate 20 at a desired height above the ground. The aperture 105 is disposed on the proximal end 35 of the elongated member 30 that is adjacent to the hand crank 25 and is configured to receive the locking pin 100 horizontally therethrough, such that the locking pin 100 protrudes radially outwardly relative to the elongated member 30 on which the aperture 105 is disposed.

In the depicted embodiment, the weight of the harness 85 biases the crossbar 45 in the second direction. Thus, the fire pit grilling apparatus 10 automatically unwinds the harness 85 from the crossbar 45 until the harness 85 is completely unwound and the grill plate 20 is at its lowest height. Thus, to lock the grill plate 20 at desired height, in which the harness 85 is wound about the crossbar 45, the locking pin 100 is inserted into the aperture 105. The biased crossbar 45 rotates the hand crank 25 in the second direction until it is immobilized by the locking pin 100, thereby locking the grill plate 20 at a desired height and preventing the crossbar 45 from automatically rotating in the second direction and unwinding the harness 85. In the depicted embodiment, the locking pin 100 comprises a collar 110 disposed and an end thereof that includes a diameter greater than a diameter of the aperture 105, such that the collar 110 prevents the locking pin 100 from sliding through the aperture 105.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A grilling apparatus, comprising:
a frame including a pair of elongated members having a proximal end and a distal end;
a crossbar having a first end a second end, the crossbar rotatably coupled to the proximal ends of the pair of elongated members, thereby interconnecting the pair of elongated members;
wherein the pair of elongated members are aligned and parallel to one another and the crossbar is perpendicular relative to the pair of elongated members;
a support base disposed at each of the distal ends of the pair of elongated members, the support bases configured to support the frame in a vertically upright position;
an adjustable harness affixed to a center of the crossbar, the harness including a cable having a proximal end and a distal end and a plurality of tethers having a first end and a second end, the proximal end of the cable removably attachable to the crossbar and the first ends of the plurality of tethers being affixed to the distal end of the cable;
a grill grate removably attachable to the second ends of the plurality of tethers, the plurality of tethers disposed evenly about a perimeter edge of the grill grate;
a hand crank coupled to the crossbar, the hand crank configured to rotate in a first direction and a second direction, thereby simultaneously rotating the crossbar upon rotation in either the first or second direction.

2) The grilling apparatus of claim 1, wherein the proximal ends of the each of the pair of elongated members include a band protruding vertically upward relative to elongated members, the band including an aperture sized to receive an end of the crossbar therethrough, wherein the band rotatably couples the crossbar to the proximal ends of the pair of elongated members.

3) The grilling apparatus of claim 2, wherein the first end and the second end of the crossbar each include a pin extending through a diameter of the crossbar and protruding radially outwardly from opposing sides of the crossbar, the pin including a length greater than a diameter of the band.

4) The grilling apparatus of claim 1, wherein each of the support bases includes a pointed tip for mounting the pair of elongated members into the ground.

5) The grilling apparatus of claim 1, comprising four tethers evenly disposed about the perimeter of the grill grate.

6) The grilling apparatus of claim 1, wherein the grill grate is attached to the plurality of tethers in a level position relative to a horizontal axis of the pair of elongated members and perpendicularly oriented relative to a longitudinal axis of the pair of elongated members.

7) The grilling apparatus of claim 1, wherein the grill grate is removably attachable to the plurality of tethers via a fastener.

8) The grilling apparatus of claim 7, wherein the fastener comprises a threaded connecting link.

9) The grilling apparatus of claim 1, wherein the grill grate includes a planar circular frame having a network of elongated rods extending diametrically across the frame.

10) The grilling apparatus of claim 1, wherein the grill grate further includes a handle disposed on the perimeter edge.

11) The grilling apparatus of claim 1, wherein the support cable is removably attachable to the crossbar via a fastener.

12) The grilling apparatus of claim 11, wherein the fastener comprises a threaded connecting link.

13) The grilling apparatus of claim 1, wherein the support cable comprises a chain composed of a metal material.

14) The grilling apparatus of claim 1, wherein each of the plurality of support tethers comprises a chain composed of a metal material.

15) The grilling apparatus of claim 1, wherein rotation of the crossbar by the hand crank in the first direction winds the harness about the crossbar, thereby decreasing a length of the harness and increasing a height of the grill grate relative to a surface.

16) The grilling apparatus of claim 15, wherein rotation of the crossbar by the hand crank in the second direction unwinds the harness about the crossbar, thereby increasing the length of harness and decreasing the height of the grill grate relative to the surface.

17) The grilling apparatus of claim 15, wherein when the harness is wound in the first direction about the crossbar, the crossbar is rotatably biased in the second direction by a weight of the harness, thereby automatically unwinding the harness from the crossbar when wound therearound.

18) The grilling apparatus of claim 17, further comprising a locking pin and an aperture disposed on the proximal end of an elongated member of the pair of elongated members that is adjacent to an end of the crossbar in which the handcrank is disposed, the aperture configured to receive the locking pin therethrough, wherein the locking pin protrudes radially outwardly relative the elongated arm, thereby halting rotation of the hand crank in the second direction.

19) The grilling apparatus of claim 18, wherein the locking pin includes a collar disposed at an end thereof, the collar including a diameter greater than a diameter of the aperture.
